(19) United States
(12) Patent Application Publication
(10) Pub. No.: US 2002/0166898 A1
(43) Pub. Date: Nov. 14, 2002

(54) Automatic adjustment of irrigation schedules during the year

(75) Inventors: Kirk Buhler, Corona, CA (US); Sylvan Addink, Iowa City, IA (US)

Correspondence Address: Robert D. Fish, Suite 706, 1440 N. Harbor Blvd., Fullerton, CA, 92835, US

(73) Assignee: Aqua Conservation Systems, Inc.

(21) Appl. No.: 09/852,231

(22) Filed: May 8, 2001

(51) Int. Cl. B05B 17/04

(52) U.S. Cl. 239/11

(57) ABSTRACT

A method of controlling irrigation to an irrigated area comprises: extrapolating an irrigation schedule at least partly as a function of at least two user entered data points; and executing the irrigation schedule by an irrigation controller. The user entered data points can all be entered at the same time or over a period of time. Furthermore, two or more user entered data points may be entered for the same date. Additionally, the user entered data points may be deleted. A warning is preferably displayed to the user (a) when a user-entered data point is projected to result in an irrigated area not receiving adequate water to meet a plant's water requirement, or (b) when an irrigated area is projected to receive excessive water.

### FIELD OF THE INVENTION

The field of the invention is irrigation controllers.

### BACKGROUND OF THE INVENTION

In arid areas of the world water is becoming one of the most precious natural resources. Meeting future water needs in these arid areas may require aggressive conservation measures. One useful aspect of conservation involves limiting the water applied to a landscape in an amount close to the actual water requirements of the plants being irrigated. However, very few irrigation controllers marketed today execute a water schedule that closely meets the actual water requirement of plants.

Many irrigation controllers have been developed for automatically controlling application of water to landscapes. Known irrigation controllers range from simple devices that control watering times based upon fixed schedules, to sophisticated devices that vary the watering schedules according to local geographic and climatic conditions.

With respect to the simpler types of irrigation controllers, a homeowner typically sets a watering schedule that involves specific run times and days for each of a plurality of stations, and the controller executes the same schedule regardless of the season or weather conditions. From time to time the homeowner may manually adjust the watering schedule, but such adjustments are usually only made a few times during the year, and are based upon the homeowner's perceptions rather than actual landscape watering needs. One change is often made in the late Spring when a portion of the yard becomes brown due to a lack of water. Another change is often made in the late Fall when the homeowner assumes that the vegetation does not require as much watering. These changes to the watering schedule are typically insufficient to achieve efficient watering.

Sophisticated irrigation controllers usually include some mechanism for automatically making adjustments to the irrigation run times to account for daily environmental variations. One common adjustment is based on soil moisture. It is common, for example, to place sensors locally in the soil, and suspend irrigation as long as the sensor detects moisture above a given threshold. Controllers of this type help to reduce over irrigating, but placement of the sensors is critical to successful operation.

More sophisticated irrigation controllers are known that employ evapotranspiration values for determining the amount of water to be applied to a landscape. Evapotranspiration (ETo) is the water loss by direct evaporation from the soil and plant and by transpiration from the plant surface. Irrigation controllers that derive all or part of the irrigation schedule from potential ETo data are discussed in U.S. Pat. No. 5,479,339 issued December 1995 to Miller, U.S. Pat. No. 5,097,861 issued March 1992 to Hopkins, et al., U.S. Pat. No. 5,023,787 issued June 1991and U.S. Pat. No. 5,229,937 issued July 1993 both to Evelyn-Veere, U.S. Pat. No. 5,208,855, issued May 1993, to Marian, U.S. Pat. No. 5,696,671, issued December 1997, and U.S. Pat. No. 5,870,302, issued February 1999, both to Oliver and U.S. Pat. No. 6,102,061, issued August, 2000 to Addink.

Because of cost and/or complicated operating requirements of controllers that derive all or part of the irrigation schedule from ETo data, most residential and small commercial landscape sites are primarily irrigated by controllers that provide inadequate schedule modification. This results in either too much or too little water being applied to the landscape, which in turn results in both inefficient use of water and unnecessary stress on the plants. Therefore, a need exists for a cost-effective irrigation system for residential and small commercial landscape sites that is capable of frequently varying the irrigation schedule based upon estimates of a plant's water requirements.

### SUMMARY OF THE INVENTION

The present invention provides a method of controlling irrigation to an irrigated area, comprising: extrapolating an irrigation schedule partly as a function of at least two user entered data points; and executing the irrigation schedule by an irrigation controller.

In addition to the at least two user entered data points, the extrapolated irrigation schedule may be partly derived from ETo data, a historical crop water use curve or any other factors that result in the application of water to the irrigated site based on the water requirements of the plants.

Preferably the extrapolated irrigation schedule is automatically generated by a microprocessor disposed in the irrigation controller. Alternatively, the microprocessor may be disposed in a personal computer or other device that interfaces with the irrigation controller.

The irrigation schedule may be based on an extrapolation step function of daily, weekly, monthly, quarterly, etc. irrigation watering changes during a calendar year. Alternatively, the irrigation schedule may be based on an extrapolation step function of irrigation watering changes during a period other than a calendar year.

The extrapolated irrigation schedule may include irrigation watering values that are identical to, or at least approximate at least one of the irrigation data points. Alternatively, none of the extrapolated irrigation watering values may be the same as any of the irrigation data points.

The user entered data points can all be entered at the same time or over a period of time. Furthermore, two or more user entered data points may be entered for the same date. Preferably the user entered data points are stored in a memory disposed in the irrigation controller. Alternatively, the user entered data points may be stored in a memory disposed in a personal computer or other device that is coupled to the irrigation controller. In a preferred embodiment the user entered data points may be deleted from the memory.

In a preferred embodiment of the present invention the irrigation controller warns the user if a user entered data point may potentially result in an irrigated area receiving excessive water that substantially exceeds a plant's water requirement or not receiving adequate water to meet a plant's water requirement.

Various objects, features, aspects, and advantages of the present invention will become more apparent from the following detailed description that describes a preferred embodiment of the invention, along with the accompanying drawings in which like numerals represent like components.

### BRIEF DESCRIPTION OF THE DRAWINGS

FIG. 1 is a schematic of an irrigation controller according to an aspect of the present invention.

FIG. 2 is a graphical representation of prior art irrigation schedules for a calendar year.

FIG. 3 is a graphical representation of extrapolated irrigation schedules for a calendar year according to an aspect of the present invention.

FIG. 4 is an alternative graphical representation of extrapolated irrigation schedules for a calendar year according to an aspect of the present invention.

FIG. 5 is a graphical representation of the water requirements for tall fescue and an extrapolated monthly irrigation schedule for tall fescue.

FIG. 6 is an alternative graphical representation of the water requirements for tall fescue and an extrapolated monthly irrigation schedule for tall fescue.

### DETAILED DESCRIPTION

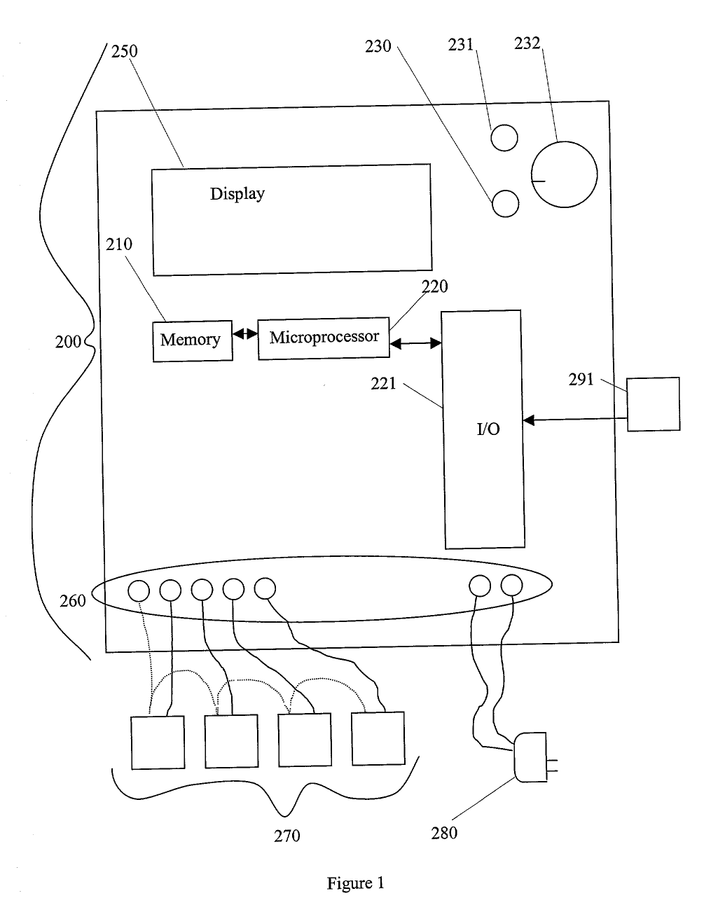

In FIG. 1 an irrigation controller 200 generally includes a microprocessor 220, an on-board memory 210, manual input devices 230 through 232 (buttons and/or knobs), an input/output (I/O) circuitry 221 connected in a conventional manner, a display screen 250, electrical connectors 260 which are connected to a plurality of irrigation stations 270 and a power supply 280 and a rain detection device 291. Each of these components by itself is well known in the electronic industry, with the exception of the programming of the microprocessor in accordance with the functionality set forth herein. There are hundreds of suitable chips that can be used for this purpose. At the present, experimental versions have been made using a generic Intel 80C54 chip, and it is contemplated that such a chip would be satisfactory for production models.

In a preferred embodiment of the present invention the controller has one or more common communication internal bus(es). The bus can use a common or custom protocol to communicate between devices. There are several suitable communication protocols, which can be used for this purpose. At present, experimental versions have been made using an I²C serial data communication, and it is contemplated that this communication method would be satisfactory for production models. This bus is used for internal data transfer to and from the EEPROM memory, and is used for communication with peripheral devices and measurement equipment including but not limited to water flow sensors, water pressure sensors, and temperature sensors.

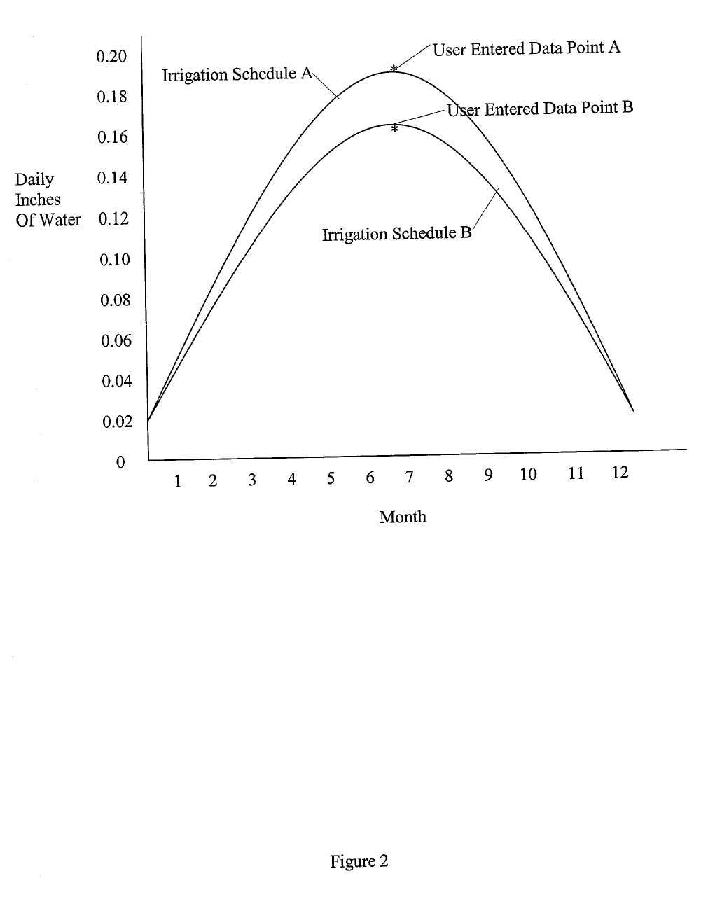

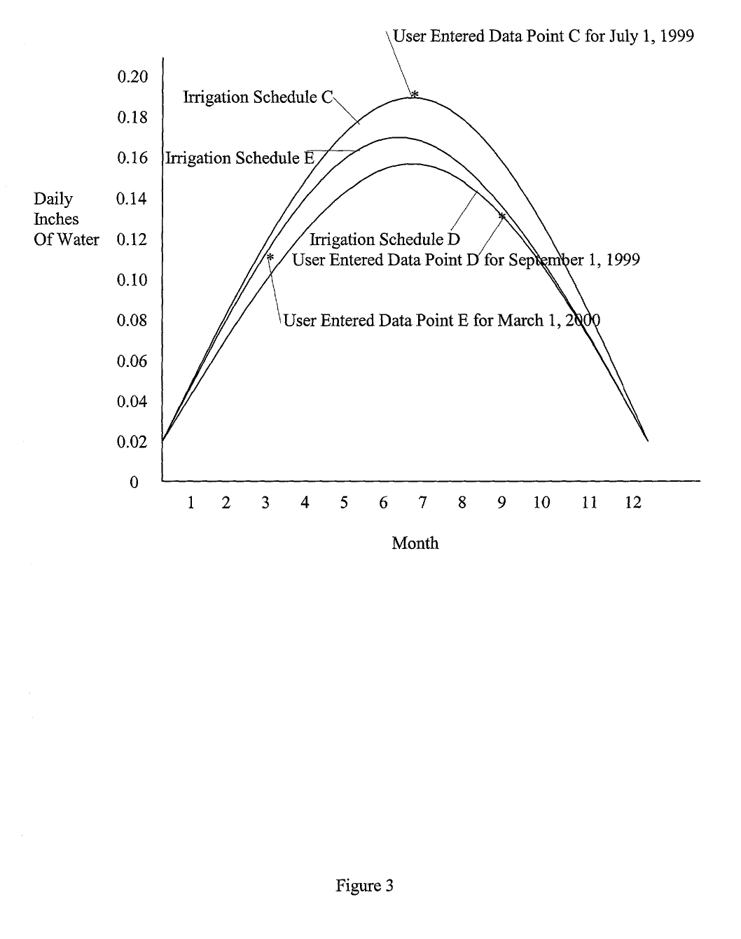

Referring to FIG. 2, with prior art devices the user enters a data point such as data point A. The data point is generally the summer run time minutes for an irrigation station. Prior art irrigation controllers would then derive an irrigation schedule A for the calendar year partly based on the user entered data point A. The irrigation controller may make automatic changes in the irrigation schedule from the user entered data point A based on ETo data for the remainder of the year. Should the user determine that too much water is being applied to the irrigated area, the user can reduce the summer run time minutes by entering a new summer run time or data point B. Of course the run time for some other date or period could be used as well to make an adjustment. In any event, the user's input is employed to derive a new yearly irrigation schedule, referred to in FIG. 2 as Irrigation Schedule B. In preferred embodiments of the present invention, irrigation schedules are automatically derived from multiple user-inputted data points. Data points may be added or removed at will, and each data point the user enters affects the irrigation schedule until it is removed from the memory. Referring to FIG. 3, it is assumed the user enters data point C for Jul. 1, 1999 that represents the summer run time minutes for an irrigation station that is irrigating Zone A. It should be appreciated the summer run time minutes may alternatively be summer inches of water applied or any other designation that reflects the amount of water to be applied to an irrigated area. User entered data point C may be based on the user's knowledge of the approximate summer run time minutes for an irrigation station. Alternatively, the user entered data point C may be based on the manufacturer's recommendation or any other basis that approximates the quantity of water that should be applied by the irrigation station to meet the summer water requirements of the plants that are growing in Zone A.

As with the prior art example in FIG. 2, irrigation schedule C may then be derived at least partly from ETo data. It is contemplated that the ETo value used may advantageously comprise current ETo (i.e., within the last week, three days, or most preferably within the last 24 hours), an estimated ETo value based upon a regression model using one or more of the factors used in calculating ETo (as for example that described in pending US patent application serial no. PCT/US00/18705), or an historical ETo value (as for example that described in pending US patent application serial no. PCT/US00/40685). Although the assumption is not necessarily valid, such data is assumed to approximate the water needs of the plants with a minimum waste of water.

In the example of FIG. 3, it is further assumed that the user determines that there is too much water being applied to Zone A during the fall and so on Sep. 1, 1999 the user enters another data point or data point D. A new irrigation schedule D is extrapolated from the new data point D, the previously entered data point C and additional information. The additional information my include information such as current ETo data, crop data, site characteristics, and other information that would result in the extrapolated irrigation schedule closely approximating the water requirements of the plants being irrigated in Zone A. In a preferred embodiment the microprocessor disposed in the irrigation controller automatically generates the extrapolated irrigation schedule. However, it should be appreciated that the extrapolated irrigation schedule may be automatically generated by a microprocessor disposed in a personal computer or other device that interfaces with the irrigation controller. The curve of the new irrigation schedule D passes through the user entered data point D but not through the user entered data point C.

As mentioned above, the extrapolated irrigation schedule D may be partly derived from ETo data. Alternatively, the extrapolated irrigation schedule may be partly derived from a historical water use curve, or any other historical data or curves that results in the application of water to the irrigated site, in a manner that more or less closely approximates the water requirements of the plants.

Referring again to FIG. 3, the user determines that on Mar. 1, 2000 there is not an adequate amount of water being applied to Zone A. The user enters another data point E. A new irrigation schedule E is extrapolated from the three data points that have been entered or data points C, D, and E as well as other information. The new irrigation schedule E curve does not pass through any of the user entered data points. This new irrigation schedule E continues to be executed by the irrigation controller to Zone A until there is a new user entered data point or until one or more of the three presently entered data points are deleted.

It is contemplated that the user will be able to interface with the irrigation controller to delete any or all of the previously entered user data points. It is contemplated that the irrigation user can interface directly with the irrigation controller to enter or delete the data points, through the manipulation of buttons, knobs, and display such as that depicted in FIG. 1. It should also be appreciated, however, that the irrigation user may interface with the irrigation controller through other means such as a personal computer coupled to the irrigation controller, or other suitable means for inputting information that could be used by the microprocessor for the generating of extrapolated irrigation schedules.

In a preferred embodiment of the present invention, the microprocessor would be programmed, in certain situations, to automatically delete previously entered data points so they do not have to be manually deleted. For example, with data points that were entered to generate an extrapolated irrigation schedule to water a newly seeded/planted crop, the microprocessor would be programmed to automatically delete the data points when the newly seeded/planted crop is established. Additionally, it is contemplated that the microprocessor would be set to automatically delete all data points other than the most recently entered data points. A specific number could be entered for how many of the most recently entered data points would be used to extrapolate the irrigation schedule with the remainder of the data points being deleted.

The user entered data points may be derived from the user's past knowledge of water use by the specific crop to be irrigated. For example, the user entered data points for certain times during the year for grass may be based on past knowledge of the summer's highest and/or the winter's lowest historic grass water requirements from previous years. It is contemplated that there may be other factors, in addition to or alternative to the past knowledge of water use by the specific crop to be irrigated, that can be considered in arriving at user entered data points. Examples include observed plant health, crop maturity, established versus newly planted crops, irrigation site location, and so forth.

It is contemplated that some of the user entered data points could be preprogrammed into the microprocessor disposed in the irrigation controller and the user would select from these preprogrammed data points. This would be advantageous with newly seeded or planted crops where the user could select two or more preprogrammed data points and the microprocessor would automatically extrapolate an irrigation schedule to efficiently water the newly seeded/planted crop. After the newly seeded/planted crop is well established, the data points could be deleted and the previously extrapolated irrigation schedule could again be executed.

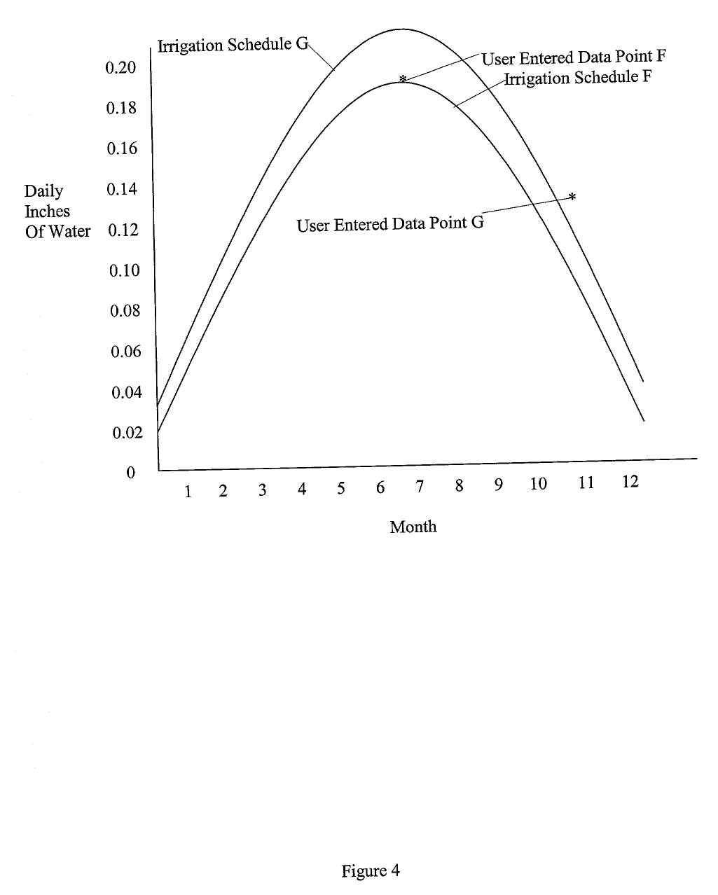

In FIG. 4 the initial user entered data point is data point F and the irrigation schedule derived from data point F is irrigation schedule F. Assume that the user observes the irrigated crop is not receiving adequate moisture on November 1, so the user enters data point G in the irrigation controller. The microprocessor automatically generates extrapolated irrigation schedule G based partly on user entered data points F and G. This increases the amount of water being applied during November but not to the level of user entered data point G. It is contemplated that a warning can be displayed to the user if the user enters a data point that may result in excessive or inadequate water being applied to the irrigated site. In the example in FIG. 4, a warning would alert the user to the potential that user entered data point G may result in substantially higher water being applied in the future to the irrigated area than is required to meet the water needs of the plants. The user may then take corrective steps by either deleting data point G in the future or by entering another data point in the future that would result in a reduction in the quantity of water being applied to the irrigated area.

The warning may be through any suitable means, including, for example, a flashing display, an audible alarm, microprocessor generated information with highlighted water irrigation applications during certain months, and other warning methods.

In a preferred embodiment the microprocessor will display the warning to the user. Advantageously, the user would comprise the individual, business or other entity that operates the irrigation controller. However, as used herein, the term “user” may include all parties having an interest in efficient irrigation at the irrigated site. In addition to the operator, this may include the landscape maintenance personnel, water district personnel, and so forth.

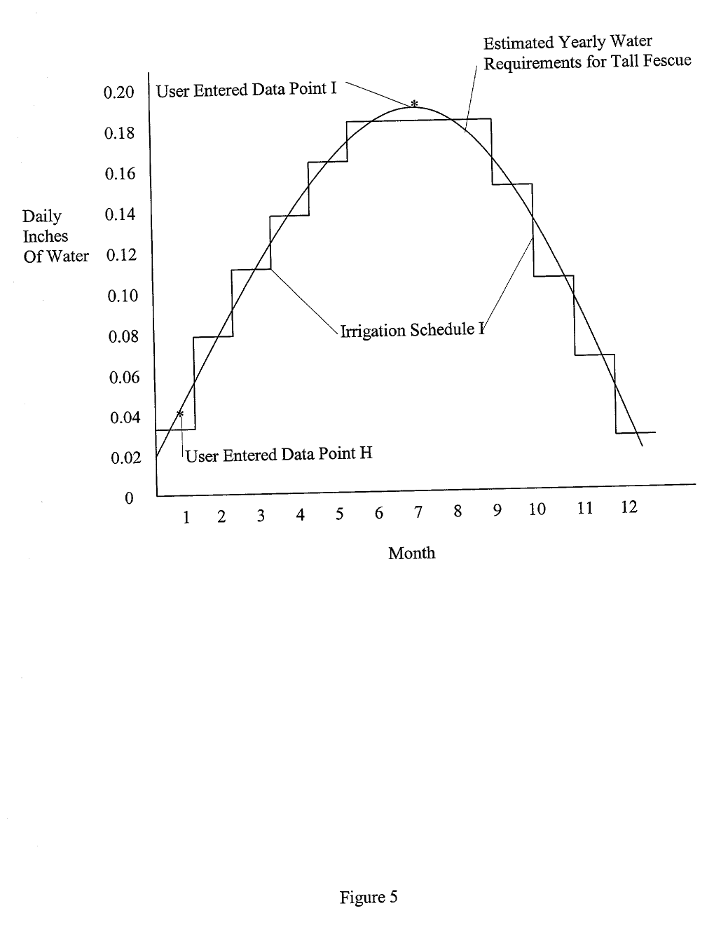

FIG. 5 is a graphical representation of the water requirements for tall fescue and an extrapolated monthly irrigation schedule for tall fescue. The user entered data points are H and I for January 15 and July 15, respectively. In a preferred embodiment of the present invention, the user not only enters data points, but also selects the irrigation application changes used by the microprocessor to extrapolate from the user entered data points. For example, a user could select daily, weekly, monthly, quarterly, or other irrigation application changes during the year. The selection could advantageously be based on a calendar year, but may be based on a time period other than a calendar year, such as the time required for a newly seed/planted area to be established or for any other defined time period.

In the example in FIG. 5, the user selects monthly irrigation application changes. The microprocessor automatically generates an irrigation schedule I based on an extrapolation step function for monthly irrigation watering changes during the calendar year. It should be appreciated that the extrapolated irrigation schedule I may involve daily watering during the summer and every other day watering during the spring, fall and winter. Furthermore, as is graphically displayed in FIG. 5, there may not always be a change in the irrigation applications for the various time periods during the year as occurred with the irrigation applications during June, July and August.

The extrapolated irrigation schedule is based partly on the two user entered data points, partly on the historical water use curve for tall fescue (See FIG. 5 and the curve designated “Estimated Yearly Water Requirements for Tall Fescue”) as well as other factors. It is contemplated that the historical water use curve for tall fescue would be preprogrammed into the microprocessor. It is further contemplated that the water usage for all irrigated crops would be preprogrammed into the microprocessor. The user, using buttons, knobs and the display on the irrigation controller (See FIG. 1), would select the crop that is to be irrigated. Although in this example the extrapolated schedule I was derived from the two user entered data points and partly from the historical water use curve, it alternatively could be partly derived from ETo data, scientific determinations on the water requirements of the specific crop to be irrigated or from any other method that closely approximates the water requirements of the crop being irrigated.

It should be appreciated that the terms “extrapolate” and “extrapolation”, etc. are used herein to include “interpolate”, “interpolation”, and so forth. Nevertheless, it is contemplated that some embodiments may exclude interpolation, and so embodiments may rely exclusively on extrapolation.

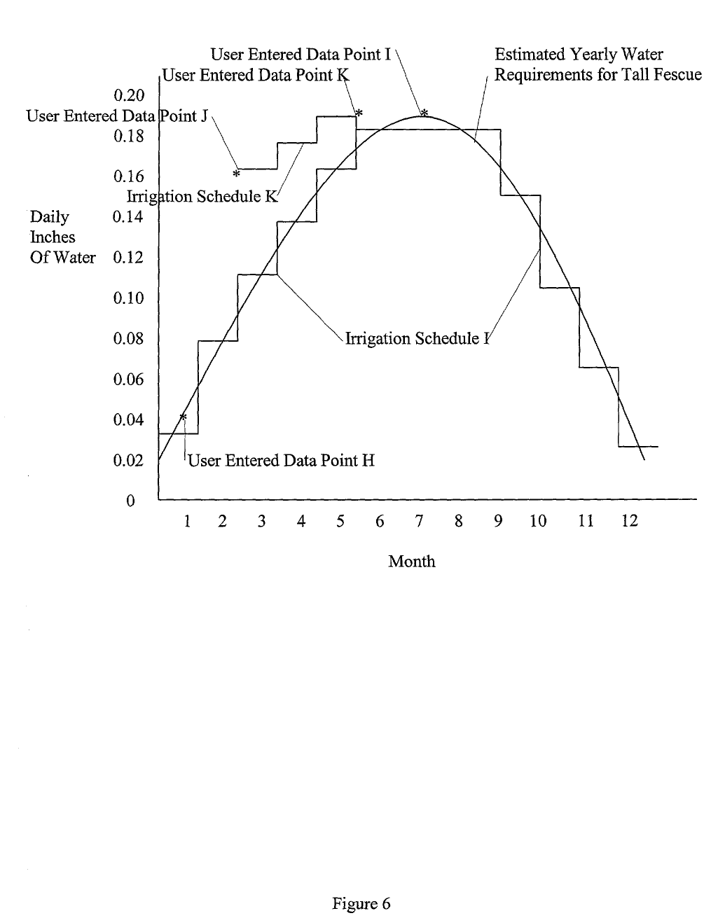

It is contemplated that the present inventive method may also be used to efficiently irrigate newly seeded lawns, ornamental plantings, recently planted crops, and so forth. Referring to FIG. 6, irrigation schedule K provides an example of deriving and executing irrigation applications for a newly seeded or sodded lawn area. For example, an area of a landscape is recently seeded or sodded on March 1 and data points J and K are entered by the user or selected from preprogrammed data points. Additionally, the user selects that there is to be three irrigation application changes during a two month period. The microprocessor automatically extrapolates an irrigation schedule K for the period from March 1 to May 1 based partly on the two user entered data points J and K. The irrigation user could have inputted that there would be five irrigation application changes and the microprocessor would have automatically generated five extrapolated step function irrigation application changes. After the grass is well established, the two user entered data points J and K would likely be deleted, so that subsequent irrigation applications would be the same as those applied to the established portion of the lawn.

Since most irrigated areas have several zones that are irrigated by different irrigation stations, each irrigation station may have different extrapolated irrigation schedules. It is contemplated that data points entered for one station will not necessarily affect the irrigation schedule executed by another station. However, it should be appreciated that some user entered data points may affect the irrigation schedules executed by all irrigation stations controlled by the irrigation controller.

Thus, specific embodiments and applications of methods and apparatus of the present invention have been disclosed. It should be apparent, however, to those skilled in the art that many more modifications besides those described are possible without departing from the inventive concepts herein. The inventive subject matter, therefore, is not to be restricted except in the spirit of the appended claims.

What is claimed is:

1. A method of controlling irrigation to an irrigated area comprising:
extrapolating an irrigation schedule partly as a function of at least two user entered data points; and
executing the irrigation schedule by an irrigation controller.

2. The method of claim 1, wherein the extrapolated irrigation schedule is at least partly derived from ETo data.

3. The method of claim 1, wherein the extrapolated irrigation schedule is at least partly derived from a historical crop water use curve.

4. The method of claim 1, wherein the extrapolated irrigation schedule is automatically generated by a microprocessor disposed in the irrigation controller.

5. The method of claim 1, wherein the irrigation schedule is based on an extrapolation step function of weekly irrigation watering changes during a calendar year.

6. The method of claim 1, wherein the irrigation schedule is based on an extrapolation step function of monthly irrigation watering changes during a calendar year.

7. The method of claim 1, wherein the extrapolated irrigation schedule includes irrigation watering values that at least approximate at least one of the irrigation data points.

8. The method of claim 1, wherein the extrapolated irrigation schedule includes irrigation watering values that are not similar to any of the irrigation data points.

9. The method of claim 1, wherein the user entered data points comprises entering all the data points at the same time.

10. The method of claim 1, wherein the user entered data points comprises entering the data points over a period of time.

11. The method of claim 10, wherein two or more user entered data points may be entered for the same date.

12. The method of claim 1, wherein the user entered data points are stored in a memory disposed in the irrigation controller.

13. The method of claim 1, wherein the user entered data points are stored in a memory disposed in a personal computer coupled to the irrigation controller.

14. The method of claim 12, wherein the user entered data points maybe deleted from the memory.

15. The method of claim 1, further comprising the irrigation controller warning the user if a user entered data point may result in an irrigated area not receiving adequate water to meet a plant's water requirement.

16. The method of claim 1, further comprising the irrigation controller warning the user if a user entered data point may result in an irrigated area receiving excessive water that exceeds a plant's water requirement.
